(19) United States
(12) Patent Application Publication
(10) Pub. No.: US 2017/0320204 A1
(43) Pub. Date: Nov. 9, 2017

(54) Systems, Devices, and/or Methods for Managing Firearm Assembly

(71) Applicants: Wendell P. Bates, Thaxton, VA (US); Donnell Mitchem, JR., Salem, VA (US)

(72) Inventors: Wendell P. Bates, Thaxton, VA (US); Donnell Mitchem, JR., Salem, VA (US)

(21) Appl. No.: 15/590,900

(22) Filed: May 9, 2017

Related U.S. Application Data
(60) Provisional application No. 62/391,664, filed on May 9, 2016.

(51) Int. Cl. B25B 31/00; F41A 3/66; B25B 23/16; F41G 11/00; F16B 19/00

(52) U.S. Cl. CPC B25B 31/00; F41A 3/66; B25B 23/16; F16B 19/004; F41G 11/001

(57) ABSTRACT

Certain exemplary embodiments can provide a pin insertion tool. The pin insertion tool can comprise a replaceable handle, a tool shaft coupleable to the replaceable handle, a pin insertion tool holder directly coupleable to the tool shaft, and a spring pin guide. The spring pin guide can comprise a base, a central portion, the central portion directly coupled to the base, and a tip directly coupled to the central portion.

### CROSS-REFERENCES TO RELATED APPLICATIONS

This application claims priority to, and incorporates by reference herein in its entirety, pending U.S. Provisional Patent Application Ser. No. 62/391,664, filed May 9, 2016.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000; and

FIG. 2 is a flowchart of an exemplary embodiment of a method 2000.

### DETAILED DESCRIPTION

Certain exemplary embodiments can provide a pin insertion tool. The pin insertion tool can comprise a replaceable handle, a tool shaft coupleable to the replaceable handle, a pin insertion tool holder directly coupleable to the tool shaft, and a spring pin guide. The spring pin guide can comprise a base, a central portion, the central portion directly coupled to the base, and a tip directly coupled to the central portion

Certain exemplary embodiments provide a tool, which was specifically designed, engineered and manufactured for precision installation of parts during firearm construction. Measurements, diameters, radii, angles, weights, geometric designs, binary construction materials and any other form (common or uncommon) of measurement of this device are based on this design. These forms of measurement have been used to develop a tool that utilizes a direct focused force to install coiled or rolled metal material into small dimensional ports designated for retention of said material for firearm operation. Dimensions allow for the tool to be struck with minimal force to achieve desired effect and seating depth of said material. Shaft design is to allow clearance of firearm while installation occurs without residual damage of the firearm.

The tool is also designed to use proprietary tool inserts for the installation of various size coiled or rolled metal material (e.g., spring/roll pins). Measurements, diameters, radii, angles, weights, geometric designs, binary construction materials and any other form (common or uncommon) of measurement of this device are based solely on this design of proprietary tool insert. The insert secures and stabilizes the coiled or rolled material (e.g., spring/roll pin) allowing for precision installation, reduced damage to firearm, reduced damage to material, and proper alignment prior to install.

Angles of exemplary embodiments are geometrically designed to concentrate the force of hammer blow directly forward to a predetermined point to allow for precision alignment and minimal concentrated effort of force. This design enhances the safety of the user, the ability to greatly reduce damage to said firearm and installation material.

The tool handle can be manufactured from a hardened polymer to allow for multiple blows of either metal or plastic construction hammers with minimal deformation. The handle has a length and a circumference to be easily held by an end user for extended duration with precision and less fatigue than certain other tools that might be utilized. The handle can comprise non-marring and/or anti-vibration material.

The construction of the tool itself lends to ease of use and replacement of parts on an individual basis if they become damaged. The tool insert, which can comprise a metal, can be individually replaced as needed. The tool body, which can comprise a metal, can be replaced if damaged or bent. The tool handle, which can comprise a polymer, can be replaced when damaged or worn beyond safe operation life.

The unique construction of this tool by way of weight, dimensions, materials, measurements, design purpose and construction uniquely identify it. Certain exemplary embodiments can be unique in appearance, form, and/or function.

A variety of tools can be utilized for mechanical installation of metal parts of a firearm. In particular, tools such as punches, wrenches, pins and hammers can be utilized. Often times persons working to assemble parts cannot locate a correct tool to complete the task and/or are inefficient because certain tools might not be available and/or difficult to locate. As well, component sizes can vary and a combination of different tools might be sought. For example, to assemble receivers with upper roll pin, a tool that installs the pin correctly without damaging parts is of value.

Without the correct tool the time to effectively install pins can be relatively long. Certain exemplary embodiments allow for installation of the spring pin with one application. Two tools were often used before the new tool was developed. The overall length of tools used before the new tool was manufactured was relatively short.

In an exemplary embodiment, a tool is described that allows installation with ease for roll/split pins. The tool configuration allows for clearance around areas on the receiver protruding out from each side. The design of the tool incorporates clearances with the receiver and installation tool for substantially zero interference when using the tool. The tool holder fits within the work area of a firearm receiver for ease of use. At the installation end of tool holder, there is a machined pin that fits inside diameter of the roll pin before collapsing. By using a hammer (e.g., a plastic and/or rubber hammer), pressure can be applied by stroking the handle of the tool holder. As the roll pin moves forward into a hole, the roll pin diameter can decrease in size as pin enters a close clearance aperture. As the outside diameter changes, the inside diameter decreases in size. After the pin is set in a correct position, the tool and holder can be removed from pin. The pin diameter can be sized such that removal is possible with two diameters with substantially zero interference.

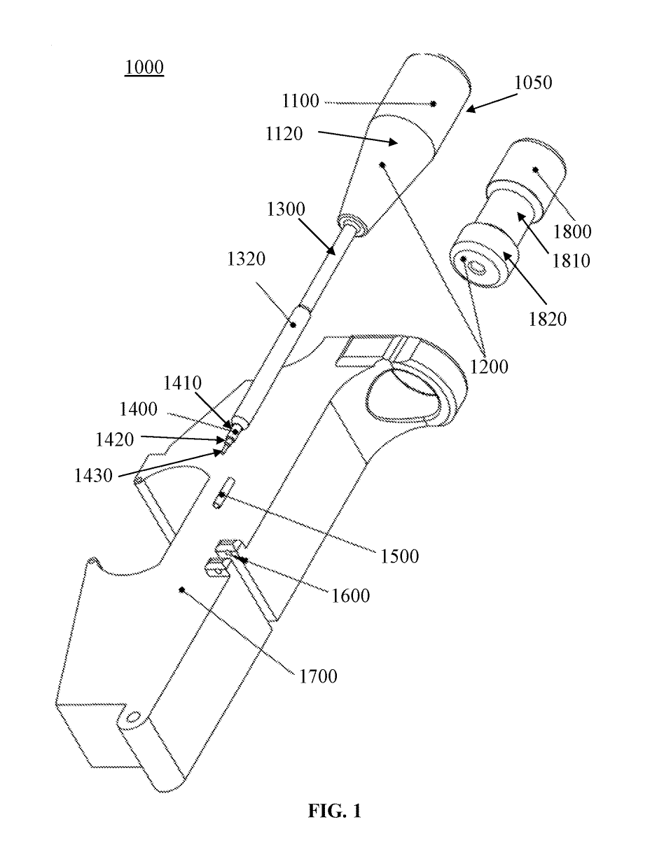

FIG. 1 is a perspective view of an exemplary embodiment of a system 1000, which comprises a pin insertion tool 1050. Pin insertion tool 1050 can be utilized in installing spring pins in a receiver 1700 of a firearm. Pin insertion tool 1050 can comprise four portions, which can be separable. Pin insertion tool 1050 can comprise:
a replaceable handle 1200;
a tool shaft 1300, in the illustrated embodiment, tool shaft 1300 comprises a substantially cylindrical portion, tool shaft 1300 can be directly coupled to replaceable handle 1200; and
a pin insertion tool holder 1320, pin insertion tool holder 1320 can comprise a substantially cylindrical portion (as illustrated), pin insertion tool holder directly coupled to tool shaft 1300 (in other embodiments, tool shaft 1300 and pin insertion tool holder 1320 can be a single unitary component); and
a spring pin guide 1400, which can comprise:
   a base 1410, which can be directly coupled to pin insertion tool holder 1320, the base can be substantially cylindrical as illustrated;
   a central portion 1420, which can be directly coupled to base 1410, central portion 1420 can be substantially cylindrical, central portion 1420 can have an outside diameter that is substantially similar to an inside diameter of a spring pin hole 1600 defined by receiver 1700 of a firearm; and
   a tip 1430, which can be directly coupled to central portion 1420, tip 1430 can be substantially cylindrical, tip 1430 can have an outside diameter that is substantially similar to an inside diameter defined by a spring pin 1500; spring pin 1500 can be constructed to be inserted into spring pin hole 1600.

Two exemplary embodiments of replaceable handle 1200 are illustrated. In the embodiment of replaceable handle 1200 coupled to tool shaft 1300, replaceable handle 1200 comprises a substantially cylindrical section 1100 and a tapered section 1120. As illustrated, tapered section 1120 has a general shape of a frustum of a cone. In the embodiment of replaceable handle 1200 not coupled to tool shaft 1300, replaceable handle 1200 comprises a cap section 1800, a central section 1810, and a base section 1820. As illustrated, central section 1810 can have a smaller diameter than cap section 1800 and/or base section 1820. A smaller diameter of central section 1310 can allow a user an improved grip on replaceable handle 1200. Surfaces of replaceable handle 1200 can be beveled or rounded for comfort of the user. In certain exemplary embodiments, replaceable handle 1200 can be coupled to tool shaft 1300 via a threaded coupling. In other embodiments, a magnetic liner can be present in replaceable handle 1200, which allows a magnetic coupling of replaceable handle 1200 to tool shaft 1300.

System 1000 can comprise spring pin 1500 and receiver 1700 of the firearm. Receiver 1700 defines spring pin hole 1600, which is constructed to receive spring pin 1500 as a part of assembly of the firearm for use.

In certain exemplary embodiments, at least one portion of pin insertion tool 1050 can be magnetic. For example, spring pin guide 1400 can be magnetically coupled to pin insertion tool holder 1320. As another example, one or more of base 1410, central portion 1420, and/or tip 1430 of spring pin guide 1400 can be magnetic such that spring pin 1500 is held magnetically by pin insertion tool 1050 as spring pin 1500 is being installed in receiver 1700.

An outside diameter of portions of pin insertion tool 1050 (e.g., base 1410, central portion 1420, and/or tip 1430 of spring pin guide 1400) can facilitate its use in installing and/or removing spring pins.

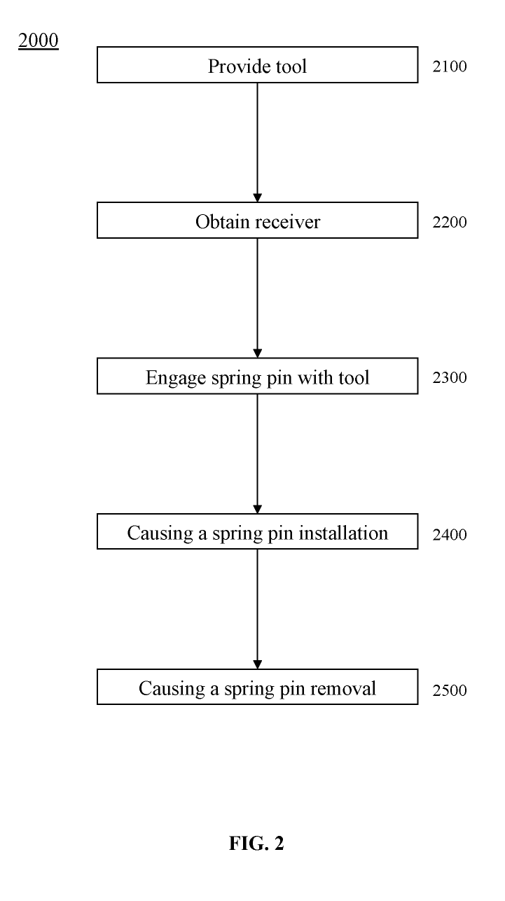

FIG. 2 is a flowchart of an exemplary embodiment of a method 2000. At activity 2100, a pin insertion tool can be provided. The pin insertion tool can comprise:
a replaceable handle;
a tool shaft, which can comprise a substantially cylindrical portion, wherein the tool shaft can be directly coupled to the replaceable handle;
a pin insertion tool holder, which can comprise a substantially cylindrical portion, wherein the pin insertion tool holder can be directly coupled to the tool shaft; and/or
a spring pin guide, which can comprise:
   a base, which can be directly coupled to the pin insertion tool holder, wherein the base can be substantially cylindrical;
   a central portion, which can be directly coupled to the base, the central portion can be substantially cylindrical, wherein the central portion can have an outside diameter that is substantially similar to an inside diameter of a spring pin hole defined by a receiver of a firearm; and
   a tip, which can be directly coupled to the central portion, the tip can be substantially cylindrical, wherein the tip can have an outside diameter that is substantially similar to an inside diameter defined by a spring pin, wherein the spring pin can be constructed to be inserted into the spring pin hole.

At activity 2200, a receiver of a firearm can be obtained. At activity 2300, a spring pin can be engaged with the pin insertion tool. At activity 2400, certain exemplary embodiments can comprise causing the pin insertion tool to be used to insert the spring pin into the spring pin hole. At activity 2500, certain exemplary embodiments can comprise causing the pin insertion tool to be used to remove the spring pin from the spring pin hole.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
base—a supporting portion of something.
can—is capable of, in at least some embodiments.
cause—to produce an effect.
central—a portion of something that is between two other portions.
comprising—including but not limited to.
configure—to make suitable or fit for a specific use or situation.
connect—to join or fasten together.
constructed to—made to and/or designed to.
couple—to link in some fashion.
coupleable—capable of being joined, connected, and/or linked together.
create—to bring into being.
cylindrical—having a shape of a surface or solid bounded by two parallel planes and generated by a straight line moving parallel to the given planes and tracing a curve bounded by the planes and lying in a plane perpendicular or oblique to the given planes.
define—to establish the outline, form, or structure of
determine—to obtain, calculate, decide, deduce, and/or ascertain.
device—a machine, manufacture, and/or collection thereof.
diameter—a width of a circular or cylindrical object.
directly—substantially without an intervening space.
firearm—a small arms weapon, as a rifle or pistol, from which a projectile is fired by gunpowder.
handle—a part of a thing sized and/or shaped specifically to be grasped or held by a hand of a user.
hole—an aperture defined by something.
insert—to put or place in.
inside—of an internal surface.
install—to connect or set in position and prepare for use.
magnetic—comprising a material that produces a magnetic field. This magnetic field is invisible but is responsible for the most notable property of a magnet: a force that pulls on ferromagnetic materials, such as iron, and attracts or repels other magnets.
may—is allowed and/or permitted to, in at least some embodiments.
method—a process, procedure, and/or collection of related activities for accomplishing something.
outside—of an external surface.
pin insertion tool—a device constructed to engage with a spring pin and facilitate insertion of the spring pin into a spring pin hole.
pin insertion tool holder—a portion of a pin insertion tool that couples a tool shaft to a spring pin guide.
portion—a part of a whole.
plurality—the state of being plural and/or more than one.
predetermined—established in advance.
provide—to furnish, supply, give, and/or make available.
receive—to get, take, acquire, and/or obtain.
receiver—a part of a firearm which provides housing for a hammer, bolt or breechblock, and firing mechanism.
repeatedly—again and again; repetitively.
replaceable—capable of being substituted for something else in a substantially non-destructive manner.
select—to make a choice or selection from alternatives.
set—a related plurality.
spring pin—a mechanical fastener that secures the position of two or more parts of a machine and/or firearm relative to each other.
spring pin guide—a portion of a pin insertion tool that is constructed to engage directly with a spring pin.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
tip—an end of a tool that is constructed to engage with a spring pin.
tool shaft—a portion of an implement coupling a handle of the implement to a working tip of the implement.
use—to employ for some purpose.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a pin insertion tool, the pin insertion tool comprising:
a replaceable handle;
a tool shaft, the tool shaft comprising a substantially cylindrical portion, the tool shaft directly coupled to the replaceable handle;
a pin insertion tool holder, the pin insertion tool holder comprising a substantially cylindrical portion, the pin insertion tool holder directly coupled to the tool shaft; and
a spring pin guide, the spring pin guide comprising:
a base, the base directly coupled to the pin insertion tool holder, the base substantially cylindrical;
a central portion, the central portion directly coupled to the base, the central portion substantially cylindrical, wherein the central portion has an outside diameter that is substantially similar to an inside diameter of a spring pin hole defined by a receiver of a firearm; and
a tip, the tip directly coupled to the central portion, the tip substantially cylindrical, wherein the tip has an outside diameter that is substantially similar to an inside diameter defined by a spring pin, the spring pin constructed to be inserted into the spring pin hole.

2. The system of claim 1, further comprising:
the spring pin.

3. The system of claim 1, further comprising:
the receiver of the firearm, the receiver of the firearm defining a pin hole constructed to receive the spring pin.

4. The system of claim 1, wherein:
at least one portion of the pin insertion tool is magnetic.

5. A method comprising a plurality of activities, comprising:
providing a pin insertion tool, the pin insertion tool comprising:
a replaceable handle;
a tool shaft, the tool shaft comprising a substantially cylindrical portion, the tool shaft directly coupled to the replaceable handle;
a pin insertion tool holder, the pin insertion tool holder comprising a substantially cylindrical portion, the pin insertion tool holder directly coupled to the tool shaft; and
a spring pin guide, the spring pin guide comprising:
a base, the base directly coupled to the pin insertion tool holder, the base substantially cylindrical;
a central portion, the central portion directly coupled to the base, the central portion substantially cylindrical, wherein the central portion has an outside diameter that is substantially similar to an inside diameter of a spring pin hole defined by a receiver of a firearm; and
a tip, the tip directly coupled to the central portion, the tip substantially cylindrical, wherein the tip has an outside diameter that is substantially similar to an inside diameter defined by a spring pin, the spring pin constructed to be inserted into the spring pin hole

6. The method of claim 5, further comprising:
causing the pin insertion tool to be used to insert the spring pin into the spring pin hole.

7. The method of claim 5, wherein:
causing the pin insertion tool to be used to remove the spring pin from the spring pin hole.
